(19) United States
(12) Patent Application Publication
(10) Pub. No.: US 2001/0046530 A1
(43) Pub. Date: Nov. 29, 2001

(54) Variable forming assembly for continuous laminate post former machine

(76) Inventor: Herbert Toews, Abbotsford (CA)

Correspondence Address: Todd N. Hathaway, Attorney at law, 119 N. Commercial St., #620, Bellingham, WA, 98225-4437, US

(21) Appl. No.: 09/819,784

(22) Filed: Mar. 27, 2001

Related U.S. Application Data
(60) Provisional application No. 60/192,182, filed on Mar. 27, 2000.

(51) Int. Cl. B29D 9/00; B32B 31/00

(52) U.S. Cl. 425/500

(57) ABSTRACT

An adjustable forming assembly for molding laminate sheet material against a curved edge of a core. A plurality of wheels or other pressure members are arranged in an angular relationship so as to define the radius of curvature that matches the curved edge of the core. The pressure members move alternately towards and away from one another so as to selectively decrease and increase the radius of curvature to match curved edges of cores having different radii. The supports for the roller wheels are mounted to first and second frames that are moved together and apart by a drive mechanism, with the wheel supports being mounted to the first frame for radial movement and to the second frame for transverse movement, so that the wheel assemblies move together and apart while maintaining the same angular relationship. The adjustable forming assembly may be included in a _{______}-type laminate post-forming machine.

### BACKGROUND

a. Field of the Invention

The present invention relates generally to methods and apparatus for post-forming a laminate sheet to a core formed of wood or other material, and, more particularly, to an assembly for use in a flow-line post-forming machine, the assembly being selectively adjustable to form laminate material to edges of differing radii.

b. Related Art

Post-forming machines are used to form the rounded edges of laminate countertops, such as those that are commonly used in kitchens, bathrooms, and so on. A core is provided which has a rounded edge, and the laminate material is applied over this and bent and adhered to the radiused corner, this process being referred to as “post-forming.” As used herein, the term “core” means any suitable base layer for use in such a construction, including, for example, a layer of wood, chip wood, plywood or MDF etc. The term “laminate”, in turn, includes any sheet material that may be applied to a core in such a construction, including, for example, plastics, melamine, wood veneers and metallic laminates. FIG. 1 shows an exemplary section of countertop 10 having this general construction. As can be seen, the core 12 is a comparably thick layer formed of chipboard or other suitable material, while the laminate 14 typically forms a comparatively thin layer that is installed on top of the core. The core is formed with a curved, smoothly radiused outer edge 16, which is important from the standpoint of appearance, durability and user comfort. The laminate layer is bent in conformance with the curved edge of the core, so as to form a seamless, radiused outer surface 18 on the edge of the countertop.

To form a laminate of about a core having a curved edge such as that which is shown, it is traditional that the laminate is first cut in accordance with the core shape, as is shown in FIG. 2, and an adhesive is applied to the laminate and/or core surface, as indicated by arrows 20, 22. The laminate is then bonded to the flat upper surface of the core, with a portion 24 overlapping the core edge. The core and laminate are then placed on a post-forming machine which heats and softens the overlap so as to allow it to bend without cracking, as indicated at 26 in FIG. 2. The forming roller assembly in the post-forming machine, as is indicated schematically at 28, then rolls the overlap so as to press the laminate into permanent contact with the profiled edge of the core.

Post-forming can be performed using a machine which holds the core and laminate in a stationary position, or using a flow-line type machine in which the core and laminate move longitudinally through the machine as the above steps are applied in a sequential fashion. The flow-line type machines tend to be superior in terms of production efficiency, and it is to this type of machine that the present invention is directed.

A number of different flow-line type post forming machines are available on the market. In general, these use forming roller assemblies made up of a series of rollers that are arranged to press sequentially against the overlapped edge of the laminate material, thereby gradually bending the edge of the laminate into contact with the curved edge of the core.

A problem with the existing types of roller assemblies used in flow-line type post- forming machines is their lack of easy adjustability. For example, different types and styles of countertops may have edges with different radii, i.e., one counter-top may have a large radius which provides a gently rounded edge, while another may have a small radius which produces a comparatively sharp 90° edge. Existing types of forming roller assemblies, however, can usually be set for only a single radius; when a core having a different edge radius is placed in the post-forming machine, the forming roller assembly must be readjusted, modified and/or changed out to match the new radius. In order to do this, the machine must be stopped, and the roller mounts must be adjusted and reset individually, since no change can be made while the machine is in operation. This is a costly and time consuming procedure, during which the machine is “down” and taken off the production line for an extended period, not only because of the difficulty of making the actual adjustments, but also because the machine must be allowed to cool before working on the forming roller assembly. Accordingly, there exists a need for a forming assembly for use in a flow- line type post-forming machine that can be adjusted quickly and easily to form laminate to edges of cores having different radii. Furthermore, there exists a need for such a forming assembly that can be adjusted without causing a significant interruption in the operation of the post-forming machine. Still further, there exists a need for such a forming assembly that can be mounted in existing types of flow-line type post-forming machines without requiring significant structural modification thereof. Still further, there exists a need for such a forming assembly that is comparatively inexpensive to construct and durable in service. Still further, there exists a need for such a forming assembly that can be operated by either manual or remote/automated means.

### SUMMARY OF THE INVENTION

The present invention has solved the problems cited above, and is an adjustable forming assembly for use in a flow-line type laminate post-forming machine. Broadly, this comprises a plurality of pressure assemblies for pressing laminate material into conformity with a curved corner of a core, the pressure assemblies being arranged in a predetermined angular relationship so as to define a radius of curvature which corresponds to the curved corner of the core material, and means for selectively moving the pressure assemblies alternately towards and apart from one another while maintaining the predetermined angular relationship, so as to selectively decrease and increase the radius of curvature which is defined thereby to correspond to curved corners having smaller and larger radii.

Preferably, the pressure assemblies are roller wheel assemblies and the wheel assemblies are configured to extend normal to the curved corner of the core as the laminate is pressed against the corner thereby.

In a preferred embodiment, the forming roller assembly comprises a first frame member which is disposed towards the curved corner of the core and which includes means for mounting each of the wheel assemblies for radially slideable movement relative thereto, a second frame member which is disposed away from the curved corner of the core and which includes means for mounting each of the roller wheel assemblies for transverse movement relative thereto, and means for selectively moving the first and second frame members towards and away from one another so as to shorten the distances between the mounting means thereon, so that the roller wheel assemblies move together and apart in response to the movement of the frame members while maintaining the predetermined angular relationship of the wheel assemblies.

The means for selectively moving the first and second frame members towards and away from one another may comprise a stationary frame member, means for selectively moving the first frame member towards the stationary frame member, and means for holding the second frame member in a stationary position relative to the stationary frame member. The means for holding the second frame member stationary relative to the stationary frame member may comprise a fixed length actuating arm having an upper end which is mounted to the stationary frame member, at least one rotatable gear which is mounted to the first frame member and which is connected to the lower end of the actuating arm for rotation thereby, and at least one gear rack which is mounted to the second frame member and which is in operative engagement with said at least one rotating gear member for moving the second frame member in an opposite direction relative to the first frame member as the first frame member moves towards and away from the stationary frame member. The means for selectively moving the first frame member towards and away from the stationary frame member may comprise a threaded shaft, which is rotatably mounted to the stationary frame member, and a sliding member which is fixedly mounted to the first frame member and which is in threaded engagement with the rotatable shaft. A hand wheel may be mounted on the threaded shaft for manual rotation thereof, or a motor may be provided for rotation of a shaft in response to remote or automatic control.

The means for mounting the roller wheel assemblies to the first frame member may comprise a plurality of tee-rails for engaging corresponding tee-slots in the wheel assemblies, the tee-rails being mounted to the first frame member in radial alignment with the pre-determined radial relationship of the wheel assemblies. The means for mounting the roller wheel assemblies to the second frame member may comprise a plurality of U-track members which engage corresponding sliding bearing members on the wheel assemblies, each U-track member being mounted to extend perpendicular to the axis of the corresponding tee-rail to which the wheel assembly is mounted. The sliding bearing member may comprise a roller bearing that is mounted to an upper end of the wheel assembly.

Each wheel assembly may comprise an elongate support member having the tee-slot formed therein, with the sliding bearing member being mounted to the upper end of the support member and the roller wheel being mounted to the lower end thereof. The roller wheel may be provided with a spring suspension for resiliently biasing the wheel against the surface of the laminate, and the spring suspension may comprise a torsion spring by which the wheel is mounted to the lower end of the elongate support member. These and other features and advantages of the present invention will be apparent from a reading of the following detailed description with reference to the associated drawings.

### BRIEF DESCRIPTION OF THE DRAWINGS

FIG. 1 is a perspective view of a section of laminated counter-top material, showing the laminate sheet bonded to the core in conformance with the rounded outer edge thereof;

FIG. 2 is a schematic view showing the sequential steps in the assembly and manufacture of the laminated counter-top material of FIG. 1;

FIG. 3 is a front, elevational view of a forming roller assembly in accordance with the present invention, showing the manner in which the assembly positions the forming wheels thereof relative to the profiled edge of the core;

FIG. 4 is a side, elevational view of the forming roller assembly of FIG. 3, showing the longitudinal arrangement of the roller wheels for sequentially pressing the laminate against the profiled edge of the core;

FIG. 5 is a perspective view of the roller wheel units of the forming roller assembly of FIGS. 3-4, showing the wheel units in the relative positions and angles in which they are mounted in the assembly;

FIG. 6 is a perspective view showing the rotatable handle and pivoting gears of the forming roller assembly that actuate movement of the roller wheel units for radial adjustment of the assembly;

FIG. 7 is a perspective view of the gear racks of the forming roller assembly that cooperate with the pivoting gear segments shown in FIG. 6 to effect movement of the roller wheel units;

FIG. 8 is a perspective view of the frame within the forming roller assembly which supports the gear racks and rail of FIG. 7 for movement relative to the pivoting gear segments of FIG. 6; and

FIG. 9 is an end, schematic view showing the positional and angular relationship of the roller wheel units of the forming roller assembly when adjusted to a first edge profile having a comparatively large radius and a second edge profile having a comparatively small radius.

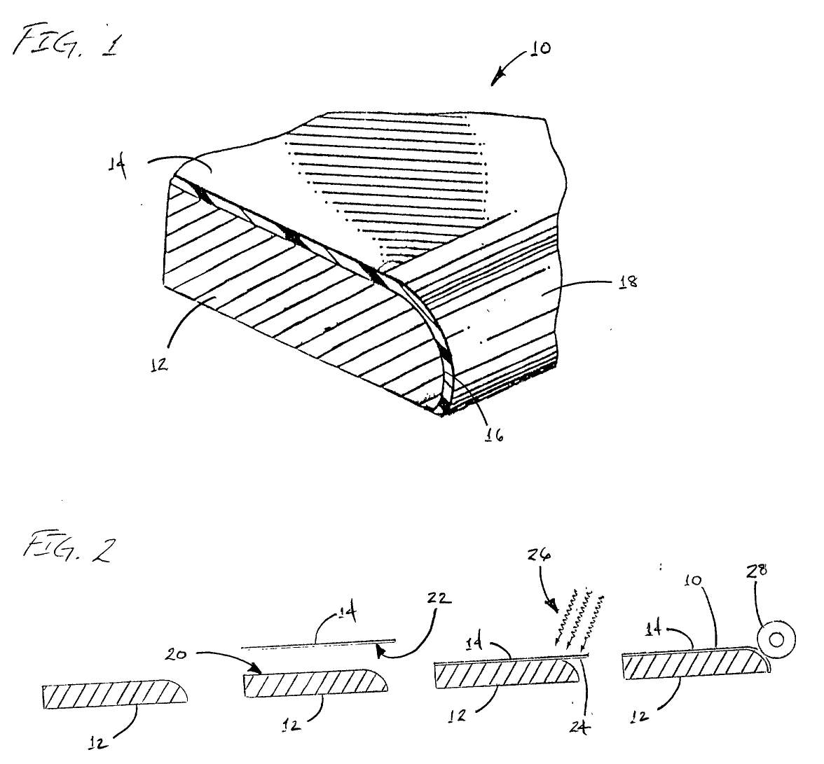

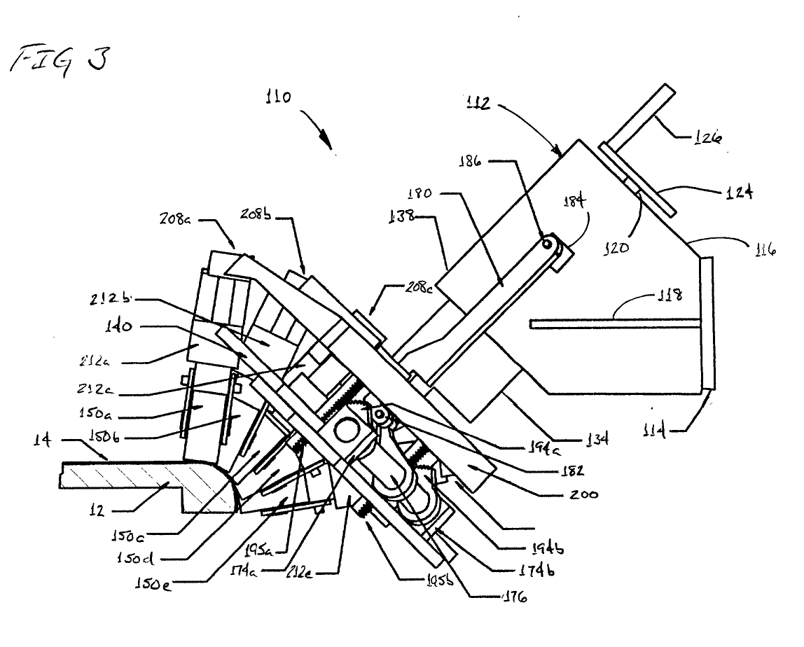

### DETAILED DESCRIPTION

The present invention provides a forming roller assembly that is mountable in existing types of flow-line post-former machines with a minimum of structural modification thereto. The assembly is quickly and easily adjustable by rotating a screw mechanism, either using a manual hand wheel or a suitable drive motor, so that the screw mechanism actuates a cooperating gear linkage to move individual roller wheel units towards or away from one another while maintaining their angular relationship so as to change the corner radius which is defined thereby.

A preferred embodiment of the invention will be described below with reference to the principle sub-assemblies thereof, followed by a description of the manner in which these subassemblies cooperate to adjust the radius that is defined by the wheel units.

a. Stationary Frame

FIG. 3 shows a forming assembly 110 in accordance with a preferred embodiment of the invention. As can be seen, this includes a stationary frame assembly 112 having a base plate 114, which is mountable to the frame of the post-forming machine. A frame plate 116 is mounted to the base plate 114, together with a welded gusset 118 for rigidity, and this supports a rotatable actuator shaft 120 at an approximate 45° angle with respect to the horizontal core. In the embodiment which is illustrated, a manual adjuster wheel 124 and crank handle 126 are mounted to the upper end of the actuator shaft, although it will be understood that in other embodiments the actuator shaft may be rotated by a motor or other mechanism, either manually or automatically controlled. The actuator shaft can be rotated at any time in order to adjust the forming radius of the assembly (as will described in greater detail below), without needing to take the post-forming machine off the production line or having to allow it to cool.

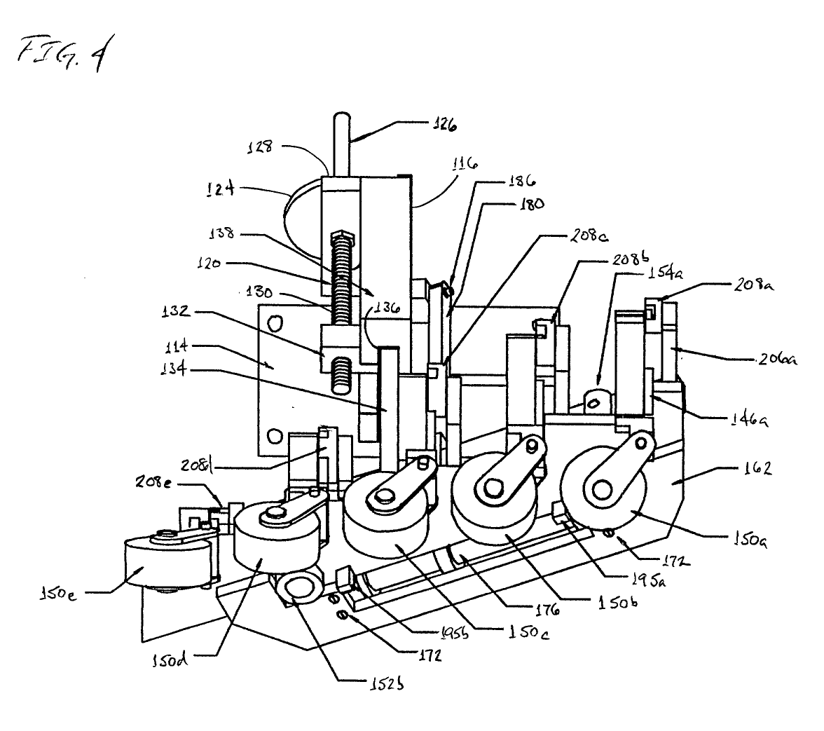

As can be seen in FIG. 4, the upper end of the actuator shaft is mounted so as to be freely rotatable, but longitudinally stationary, within a corresponding bore in a face plate 128 which is mounted transversely to the upper end of plate member 116. The lower end of the actuator shaft, in turn, is provided with threads 130, and is in threaded engagement with a cooperating bore in slider block 132. The slider block is fixedly mounted (e.g., welded) to a sliding actuator rail 134 (see also FIG. 3) that is received for longitudinally movement in an inverted channel 136 formed in the bottom of a guide member 138, the latter being mounted to the upper edge of the frame plate 116.

The actuating rail and guide channel extend parallel to the rotatable shaft (i.e., at a 45° angle to horizontal), and the face plate 128 is fixedly mounted to the upper end of the frame plate 116. Thus, by rotating the adjustment wheel 124 first one way and then the other, the actuating rail 134 is moved alternately inwardly and outwardly relative to the stationary frame assembly 112, along an axis parallel to that of the actuator shaft 120.

b. Moving Frame

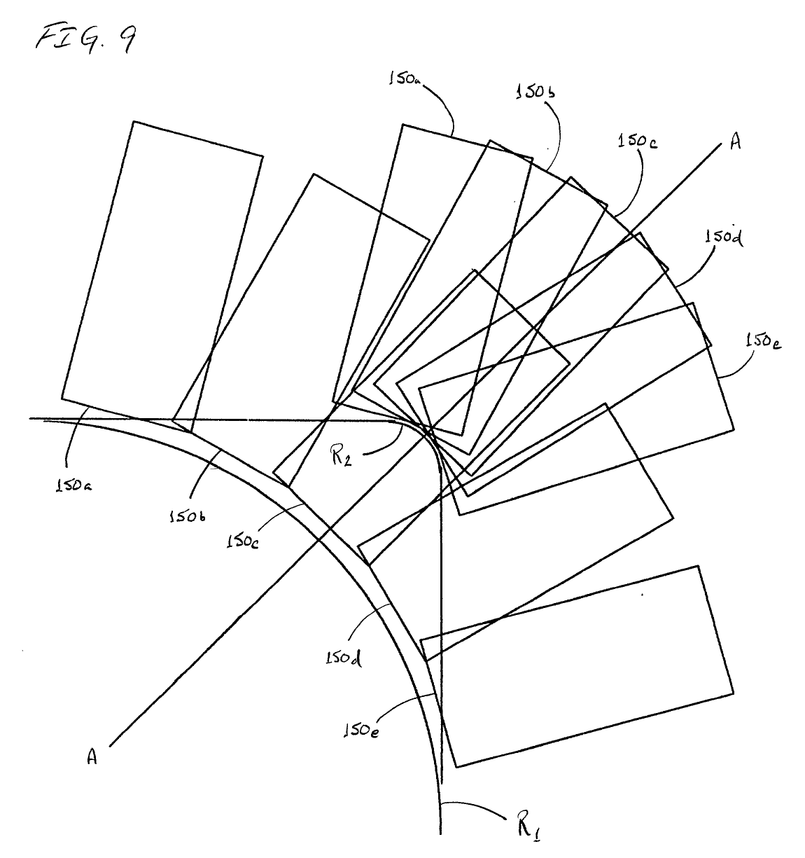

As can be seen in FIG. 8, the sliding rail 134 forms a part of the moving frame assembly 140, the lower end of the rail being welded or otherwise fixedly mounted to the a transverse support plate 142. Accordingly, it will be understood that frame assembly 140 will move alternately towards and away from the stationary frame 112 as rail 134 retracts and extends in response to rotation of actuator shaft 120.

A series of tee-rails 146a-e (146e not being visible in FIG. 8) is mounted along the upper edge of plate 142 for supporting the individual roller wheel units 150a-e (see FIG. 5) in sliding engagement therewith, as will be described in greater detail below. First and second guide sleeves 152a, 152b are also formed in support plate 142, for supporting first and second guide rods 154a, 154b on gear rack assembly 160 in sliding engagement therewith, as will also be described in greater detail below.

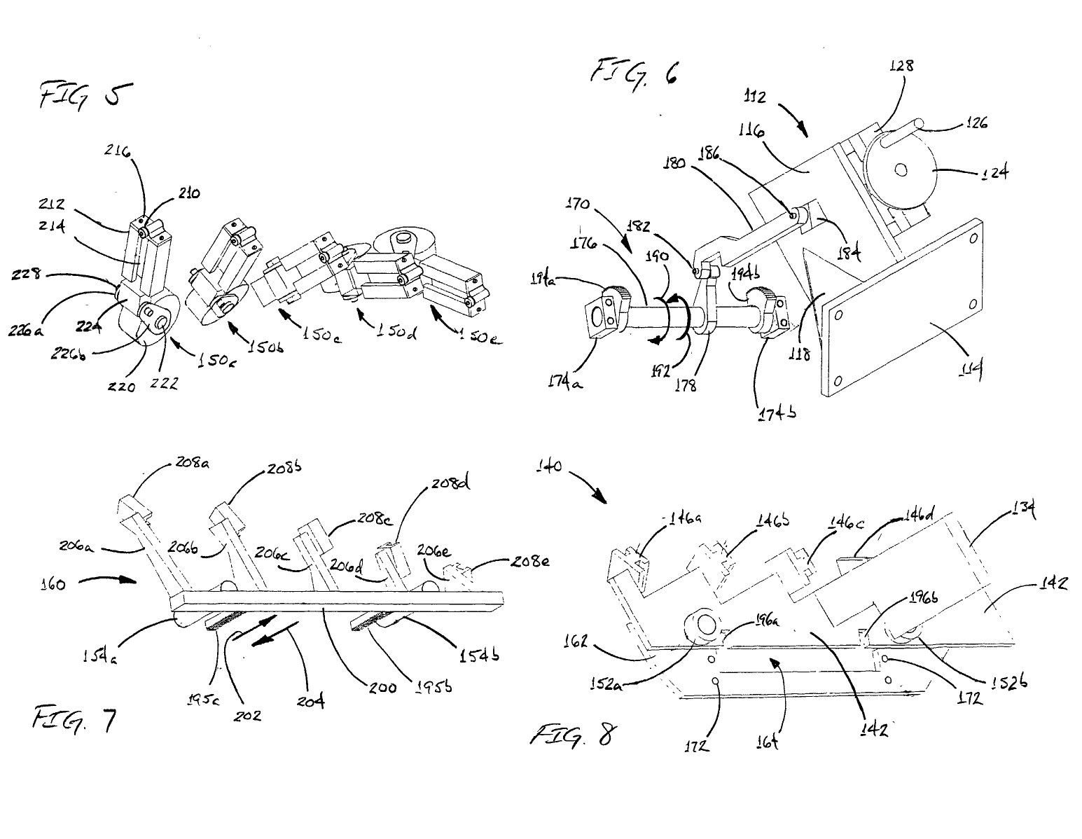

Finally, a lower support plate 162 is welded or otherwise secured in overlapping relationship to the main support plate 142 so as to extend generally downwardly and parallel to the main support plate. As can be seen, the two support plates cooperate to define an elongate opening 164 for receiving the pivoting gear assembly 170 (see FIG. 6). Bores 172 are provided proximate the ends of the opening for receiving the mounting bolts (not shown) which secure the pillow blocks 174a, 174b at the end of the gear assembly to lower support plate 162.

c. Rotating Gear Assembly

As was noted above, and as is shown in FIG. 6, the pillow blocks 174a, 174b of the rotating gear assembly 170 are mounted to the lower plate of the moving frame assembly. The pillow blocks support the ends of an elongate shaft 176 in rotating engagement, with a bell crank 178 being fixedly mounted to the shaft near its center. The outer end of the bell crank is mounted to the end of a fixed-length actuating arm 180 by a pivot connection 182, with the upper end of the arm being attached to a support bracket 184 on the stationary support frame 112 by a second pivot connection 186. Thus, as the moving frame assembly 140 moves inwardly and outwardly relative to the stationary frame assembly 112 in the manner which has been described above, the fixed length actuating arm 180 causes the shaft 176 of the rotating gear assembly to rotate alternately towards and away from the profiled edge of the core, as indicated by arrows 190 and 192.

Gear segments 194a, 194b are mounted on the ends of shaft 176 so as to rotate together therewith, and are in operative engagement with corresponding gear racks 195a, 195b on the sliding frame assembly 160. Rotation of the shaft/gear segments thus causes the sliding frame assembly to move inwardly and outwardly with respect to the moving frame assembly 140, as will be described in greater detail below. As can also be seen in FIG. 8, slots 196a, 196b are provided to accommodate rotation of the gear segments relative to the support plates of the moving frame assembly 140.

d. Sliding Frame Assembly

As can be seen in FIG. 7, the sliding frame assembly 160 includes a main cross-bar 200 to which the guide rods 154a, 154b and gear racks 195a, 195b are fixedly mounted in parallel, spaced-apart relationship. As was described above, the guide rods 154a, 154b cooperate with the guide bushings 152a, 152b in the moving frame assembly 140 so as to slide therethrough, while the gear racks 195a, 195b engage the teeth of the gear segments 194a, 194b of the rotating gear assembly 170.

Thus, motion of the moving frame assembly 140 away from the stationary frame assembly 112 (as the rail member 134 extends in response to rotation of the hand wheel) causes the gear shaft to rotate in the direction indicated by arrow 190 in FIG. 6, thereby drawing the sliding frame assembly towards the stationary frame assembly, in the direction indicated by arrow 202 in FIG. 7. Rotation of the hand wheel in the opposite direction causes the moving frame assembly 140 to retract towards the stationary frame assembly 112, so that the sliding frame assembly 160 is driven downwardly by the gears and away from the stationary frame assembly, in the direction indicated by arrow 204. In other words, the sliding frame assembly 160 moves in the opposite direction from the moving frame assembly 140 as the adjustment shaft is rotated in one direction or the other, the net effect being that the sliding frame remains in an essentially stationary position relative to the stationary frame 112 as the moving frame moves towards and away from the latter.

As can be seen with further reference to FIG. 7, a series of support arms 206a-e is also mounted to the cross-bar 200 in spaced-apart, generally parallel relationship, at an approximately 90° angle to the guide rods 154a, 154b and the gear racks 195a, 195b. The first arm member 206a is the longest and is located towards the front of the assembly, i.e., towards the side from which the laminate and core enter the forming roller assembly, and the remaining arms 206b-e are progressively shorter.

Identical U-channel members 208a-e are mounted to the outer ends of the arm members 206a-e, each of which is configured to engage and retain a corresponding bearing roller 210 on the upper end of an individual wheel assembly 150 (see FIG. 5). Outward and inward forces on the wheel assemblies (e.g., the vertical pressures which are transmitted into the assembly as the wheels force the laminate towards the core material) are thus transferred into the upper and lower walls of the U-channels 208-e, and from there through support arms 206a-e into the main cross bar 200 of the sliding frame assembly. Furthermore, each U-channel member cooperates with the bearing roller to define a travel path which extends in a direction perpendicular to the associated tee-rail 146 to which the assembly is mounted, and which permits the assembly to accommodate the transverse movement which develops between the wheel assemblies as the frame assemblies 140 and 160 move inwardly and outwardly relative to one another.

e. Wheel Assemblies

FIG. 5 shows the series of identical wheel assemblies 150a-e that are mounted in the forming roller assembly. As can be seen with reference to wheel assembly 150a, each assembly includes an elongate support member 212 having a tee-slot 214 formed in the forward side thereof. The tee-slot is configured to engage the corresponding tee-rail on the moving frame 140 so as to permit the wheel support to slide upwardly and downwardly thereon while maintaining a constant angular alignment (as defined by the tee-rail), and the tee-rails also absorb the “drag” force which is transferred into the assembly as the wheels move over the laminate.

As was noted above, a bearing roller 210 is mounted to the top of each of the wheel supports, by means of a bearing holder 216, so that the roller faces in a forward direction for being received in its U-channel member. A roller wheel 220, in turn, is mounted to the bottom end of each wheel support, preferably using a spring suspension that biases the roller wheel against the laminate material. In the embodiment that is illustrated, the axle 222 of the roller wheel is connected to a torsion spring mechanism 224 by a pair of rearwardly angled side-plates 226a, 226b and a mounting pin 228. Thus, the roller wheels are held firmly yet yieldingly against the laminate so as to provide the pressure necessary to force the laminate into conformance with the edge of the core.

Although roller wheels are employed in the preferred embodiments of the present invention, it will be understood that other forms of pressure members may be used in place of or in addition to the roller wheels, such as sliding skids or spring-loaded shoes, for example.

f. Angular Relationship and Operation

As can be seen in the figures, particularly in FIGS. 3 and 5-8, the wheel assemblies and movable components of the assembly are arranged in radial alignment about a common center. In the five-wheel assembly that is shown in the drawings, the roller wheels define an approximate 60° arc around the common center; it will be understood, however, that in other embodiments there may be more or fewer wheel assemblies, and they may describe a larger or smaller arc than that which is shown herein.

As was noted above, the threaded adjustment shaft and sliding support 134 are aligned at an approximate 45° angle (assuming that the core is aligned in a generally horizontal plane). This angle is represented by the axis “A-A” in FIG. 9, and it will be seen that the middle wheel assembly 150c is also aligned with this axis. The wheel assemblies 150a, 150b in front of this are aligned at incrementally greater angles (i.e., roller wheel 150b is aligned approximately 60° above horizontal, and roller wheel 150a is aligned at approximately 75°), while the following wheel assemblies are aligned at incrementally lower angles (i.e., 30° above horizontal for 150d, 15° for 150e). These relative angles are fixed, due to the fixed angular relationship of the tee-rails 146a-e on the moving frame assembly 140. As was noted above, however, the wheel assemblies are free to move laterally relative to the sliding frame assembly 160 by virtue of the U-channel members 208a-e, which are aligned at 90° angles to the tee-rails.

Thus, referring to FIGS. 3 and 9, when hand wheel 124 is rotated in the clockwise direction, the moving frame 140 is pulled upwardly towards stationary frame 112. This causes the actuating arm 180 to rotate the gear assembly, so that gear segments 194a, 194b cooperate with gear racks 195a, 195b to move the sliding frame 200 downwardly towards the moving frame 140, thus forcing the wheel assemblies out of the moving frame (i.e., towards the lower left corner in FIG. 9) and causing a shortening of the distance between the tee-rails 212a-e and the U-channel members 208a-e. The angular relationship of the U-channel members ensures that the wheel assemblies move the same amount of distance simultaneously as this is done. For example, at a ratio of approximately 1:4:1, 1.4 inch movement of the moving frame 140 into the stationary frame 112 produces about 1.0 inch of movement of the central wheel assembly in the opposite direction, due to about 0.4 inch upward movement of the rotating gear assembly itself.

As a result, the wheel assemblies move from a relatively spread-apart configuration in which they define a comparatively large radius forming R₁, as is shown in FIG. 9, to a “bunched together” configuration in which they define in comparably small forming radius R₂ Reversing the direction of rotation of the hand wheel (i.e., rotating it in the counter-clockwise direction) forces the wheel assemblies back apart, so that these again define a comparatively large forming radius R₁. Viewed another way, since the angular relationship between the wheel assemblies remains constant, the common radial center which is defined by the wheel assemblies is closer to the corner of the core when the assemblies are brought together by the apparatus, and is further from the corner when they are spread apart.

Since the central wheel assembly 150c remains in an essentially stationary position relative to the other wheel assemblies as the latter move inwardly and outwardly relative thereto, it will be understood that in some embodiments the central roller wheel assembly (i.e., that wheel assembly which extends parallel to the primary axis of adjustment) may be hard-mounted within the assembly, rather than riding on a tee-rail and U-channel member as is shown herein. The illustrated embodiment, however, has the advantage of using standardized components for all of the wheel assemblies, which tends to facilitate and reduce the cost of manufacture.

For ease of illustration, FIG. 9 shows the wheel assemblies (and the radii which are defined thereby) in their positions relative to the moving frame assembly 140. As was described above, the moving frame assembly 140 which moves inwardly and outwardly relative to the stationary frame and the core material while the wheel assemblies remain in the area where they press against the corner of the core.

It is to be recognized that various alterations, modifications, and/or additions may be introduced into the constructions and arrangements of parts described above without departing from the spirit or ambit of the present invention. For example, the tee-slots and rails and U-channels described above may have other suitable interfitting configurations for holding and guiding their respective members. Furthermore, although the preferred embodiment described above employs screw and gear mechanisms to provide the motions of its components, it will be understood that hydraulic, pneumatic, or other forms of drive mechanisms may be used to provide corresponding motions in other embodiments of the invention. The invention is therefore to be limited only by the appended claims.

What is claimed is:

1. An adjustable forming assembly for molding laminate sheet material against a curved edge of a core, said adjustable forming assembly comprising:
a plurality of pressure members for forcing said laminate material against said curved edge of said core, said pressure members being mounted in a predetermined angular relationship so as to define a radius of curvature that corresponds to said curved edge of said core; and
means for selectively moving said pressure members alternately towards and away from one another while maintaining said predetermined angular relationship, so as to selectively decrease and increase said radius of curvature which is defined by said pressure members to match curved edges of cores having smaller and larger radii.

2. The adjustable forming assembly of claim 1, wherein said pressure members comprise a plurality of roller wheels.

3. The adjustable forming assembly of claim 2, wherein said roller wheels are spaced apart along a predetermined direction of flow of said core and laminate material at progressively increasing angles, so that as said core and laminate material move in said direction of flow said roller wheels progressively bend said laminate material to match said curved edge of said core.

4. The adjustable forming assembly of claim 2, wherein said wheel assemblies are mounted so as to extend substantially normal to said curved edges of said core at both of said smaller and larger radii thereof.

5. The adjustable forming assembly of claim 1, wherein said means for selectively moving said pressure members towards and away from one another comprises:
a first frame member which is disposed towards said curved edge of said core, said first frame member including means for mounting said pressure members to said first frame member for radially aligned movement relative thereto;
a second frame member which is disposed away from said curved edge of said core, said second frame member including means for mounting said pressure members to said second frame member for transverse movement relative thereto; and
means for selectively moving said first and second frame members towards and away from one another so as to shorten and lengthen a distance between said means for mounting said pressure members to said first and second frame members, so that said pressure members move alternately towards and away from one another while maintaining said predetermined angular relationship.

6. The adjustable forming assembly of claim 5, wherein said means for selectively moving said first and second frame members towards and away from one another comprises:
a stationary frame member;
means for selectively moving said first frame member towards and away from said stationary frame member; and
means for holding said second frame member in a stationary position relative to said stationary frame member.

7. The adjustable forming assembly of claim 6, wherein said means for holding said second frame member stationary relative to said stationary frame member comprises:
a fixed length actuating arm having an upper end mounted to said stationary frame member;
at least one rotatable gear member mounted to said first frame member and operatively connected to a lower end of said fixed length actuating arm for rotation thereby; and
at least one gear rack mounted to said second frame member in operative engagement with said rotatable gear member for moving said second frame member in an opposite direction from said first frame member as said first frame member moves towards and away from said stationary frame member.

8. The adjustable forming assembly of claim 7, wherein said means for selectively moving said first frame member towards and away from said stationary frame member comprises:
a threaded shaft having an upper end which is rotatably mounted to said stationary frame member and a lower end which is in threaded engagement with a sliding member, said sliding member being operatively connected to said first frame member so that said first frame member moves alternately towards and away from said stationary frame member in response to rotation of said adjustment shaft.

9. The adjustable forming assembly of claim 8, wherein said means for selectively moving said first frame member towards and away from said stationary frame member further comprises:
a handwheel mounted to said threaded shaft for selective manual rotation of said shaft.

10. The adjustable forming assembly of claim 8, wherein said means for selectively moving said first frame member towards and away from said stationary frame member further comprises:
a motor mounted to said threaded adjustment shaft for selectively rotating said shaft in response to a control input.

11. The adjustable forming assembly of claim 5, wherein said plurality of pressure members comprises:
a plurality of roller wheel assemblies.

12. The adjustable forming assembly of claim 11, wherein said means for mounting said pressure members to said first frame member for radially aligned movement comprises:
a plurality of tee-rails in operative engagement with corresponding tee-slots in said roller wheel assemblies, said tee-rails being mounted to said first frame member so as to extend in alignment with said predetermined angular relationship of said pressure members.

13. The adjustable forming assembly of claim 12 wherein said means for mounting said pressure members to said second frame member for transverse movement comprises:
a plurality of U-track members in operative engagement with corresponding sliding bearing members on said roller wheel assemblies, each said U-track member being mounted to said second frame member so as to extend perpendicular to said tee-rail with which said wheel assembly is in engagement.

14. The adjustable forming assembly of claim 13, wherein said sliding bearing member comprises:
a roller bearing which is mounted to an upper end of each roller wheel assembly.

15. The adjustable forming assembly of claim 14 wherein each said roller wheel assembly comprises:
an elongate support member having said tee-slot formed longitudinally therein, and having said sliding bearing mounted to an upper end thereof and said roller wheel mounted to a lower end thereof.

16. The adjustable forming assembly of claim 15, wherein each said wheel assembly further comprises:
means for resiliently biasing said roller wheel against said laminate material as said laminate material is formed against said curved edge of said core.

17. The adjustable forming assembly of claim 16 wherein said means for biasing said roller wheel against said laminate material comprises:
a torsion spring connecting said roller wheel to said lower end of said support member.

18. A laminate post-forming machine, comprising:
means for feeding laminate sheet material and a core having a curved edge along a predetermined direction of flow through said machine;
means for heating said laminate material so as to soften said laminate material as said material is fed through said machine; and
an adjustable forming assembly for molding said softened laminate sheet material against said curved edge of said core, said adjustable forming assembly comprising:
a plurality of pressure members for forcing said laminate material against said curved edge of said core, said pressure members being mounted in a predetermined angular relationship so as to define a radius of curvature that corresponds to said curved edge of said core; and
means for selectively moving said pressure members alternately towards and away from one another while maintaining said predetermined angular relationship, so as to selectively decrease and increase said radius of curvature which is defined by said pressure members to match curved edges of cores having smaller and larger radii.

19. The laminate post-forming machine of claim 18, wherein said pressure members comprise a plurality of roller wheels.

20. The laminate post-forming machine of claim 19, wherein said roller wheels are spaced apart along said predetermined direction of flow of said core and said laminate material at progressively increasing angles, so that as said core and laminate material move in said direction of flow said roller wheels progressively bend said laminate material to match said curved edge of said core.

21. The laminate post-forming machine of claim 20, wherein said wheel assemblies are mounted so as to extend substantially normal to said curved edges of said core at both of said smaller and larger radii thereof.

22. The laminate post-forming machine of claim 18, wherein said means for selectively moving said pressure members towards and away from one another comprises:
a first frame member which is disposed towards said curved edge of said core, said first frame member including means for mounting said pressure members to said first frame member for radially aligned movement relative thereto;
a second frame member which is disposed away from said curved edge of said core, said second frame member including means for mounting said pressure members to said second frame member for transverse movement relative thereto; and
means for selectively moving said first and second frame members towards and away from one another so as to shorten and lengthen a distance between said means for mounting said pressure members to said and second first frame members.

23. The laminate post-forming machine of claim 22, wherein said means for selectively moving said first and second frame members towards and away from one another comprises:
a stationary frame member;
means for selectively moving said first frame member towards and away from said stationary frame member; and
means for holding said second frame member in a stationary position relative to said stationary frame member.

24. The laminate post-forming machine of claim 23, wherein said means for holding said second frame member stationary relative to said stationary frame member comprises:
a fixed length actuating arm having an upper end mounted to said stationary frame member;
at least one rotatable gear member mounted to said first frame member and operatively connected to a lower end of said fixed length actuating arm for rotation thereby; and
at least one gear rack mounted to said second frame member in operative engagement with said rotatable gear member for moving said second frame member in an opposite direction from said first frame member as said first frame member moves towards and away from said stationary frame member.

25. An adjustable forming assembly for molding laminate sheet material against a curved edge of a core, said adjustable forming assembly comprising:
a plurality of roller wheel assemblies, each said roller wheel assembly comprising:
an elongate support member having a longitudinal guide slot, and a roller wheel mounted on a lower end of said support member and a bearing member mounted on an upper end of said support member;
a first frame assembly, comprising:
a first rigid frame member; and
a plurality of guide rails mounted on said first frame member in longitudinal sliding engagement with said guide slots in said support members, said guide rails being spaced apart and mounted in a predetermined angular relationship;
a second frame assembly, comprising:
a second rigid frame member; and
a plurality of guide channels mounted on said second frame member in transverse sliding engagement with said bearing members on said upper ends of said support members, said guide channels being aligned perpendicular to said guide rails on said first frame assembly; and
means for selectively moving said first and second frame assemblies towards and away from one another, so that in response to said frame assemblies moving towards one another said wheel assemblies move together while maintaining said predetermined angular relationship so as to define a first radius of curvature that matches a curved edge of a core having a comparatively small radius, and in response to said frame assemblies moving away from one another said wheel assemblies move apart to define a second radius of curvature that matches a curved edge of a core having a comparatively large radius.
